(19) United States
(12) Patent Application Publication
(10) Pub. No.: US 2021/0135490 A1
(43) Pub. Date: May 6, 2021

(54) IMPROVED POWER MANAGEMENT CIRCUITRY FOR ENERGY-HARVESTING DEVICES

(71) Applicant: DRAYSON TECHNOLOGIES (EUROPE) LIMITED, London (GB)

(72) Inventors: Alessandro REVELANT, London (GB); Alessandro VINCO, London (GB); Bruno FRANCISCATTO, London (GB)

(21) Appl. No.: 16/476,562

(22) PCT Filed: Jan. 12, 2018
(86) PCT No.: PCT/GB2018/050090

§ 371 Date: Jul. 9, 2019

(30) Foreign Application Priority Data
Jan. 13, 2017 (GB) 1700656.0

(51) Int. Cl. H02J 50/00; H02J 50/20; G06K 19/07

(52) U.S. Cl. CPC H02J 50/001; G06K 19/0709; H02J 50/20

(57) ABSTRACT

Detector circuitry (12) for controlling the operation of a power management module (14) of an energy-harvesting device (10), the detector circuitry comprising: an input (13) for receiving an electrical input representative of a level of harvestable power (Vin); and a trigger coupled to the input and operable to generate an activation signal for switching on the power management module via enabler input (15); wherein the trigger is configured to generate the activation signal upon detecting at least a threshold level of harvestable power, and not to generate the activation signal upon detecting less than the threshold level of harvestable power. Also provided is a method of controlling the operation of a power management module of an energy-harvesting device, the method comprising: receiving an electrical input representative of a level of harvestable power; generating an activation signal for switching on the power management module upon detecting at least a threshold level of harvestable power; and not generating the activation signal upon detecting less than the threshold level of harvestable power.

### FIELD OF THE INVENTION

The present invention relates to electronic circuitry for use in energy-harvesting devices. It is particularly applicable, but by no means limited, for use in wireless sensor devices.

### BACKGROUND TO THE INVENTION

Electrical devices require electrical power to operate. Wireless electrical devices often use a battery as a source of electrical power. However, as a consequence, the length of time for which the device can be used tends to be limited by the life of the battery (i.e. the length of time until the battery needs to be replaced or recharged).

To reduce dependency on battery life, wireless energy-harvesting devices have been developed which harvest energy from an external source, in order to power the device and/or to charge an on-board battery. For example, certain energy-harvesting devices are configured to harvest energy from an electromagnetic field in which the device is located. Such an electromagnetic field may be produced by a radio frequency (RF) source. For example, an RF transmitter used for broadcast or wireless telecommunications purposes may act as a source of harvestable energy (or “harvesting source”).

Such an energy-harvesting wireless device may be a telecommunications device of some kind. Alternatively the purpose of the device may be unrelated to telecommunications. The device may be permanently located within the electromagnetic field in use, or it may only be present in the electromagnetic field intermittently or occasionally (e.g. for the specific purpose of charging an on-board battery).

State-of-the-art energy-harvesting wireless devices include, in the device's energy-harvesting circuitry, a power management module (PMM) for delivering harvested electrical power to associated circuitry and/or to an on-board battery, to charge it. In such state-of-the-art devices the PMM is always active, even when there is no power available from the harvesting source; in this state the internal power consumption of the PMM represents a load for the battery which may affect the battery life.

There is therefore a desire to regulate the operation of a PMM in an energy-harvesting device, to reduce the extent to which it represents a load for the battery.

### SUMMARY OF THE INVENTION

According to a first aspect of the present invention there is provided detector circuitry for controlling the operation of a power management module of an energy-harvesting device, the detector circuitry comprising: an input for receiving an electrical input representative of a level of harvestable power; and a trigger coupled to the input and operable to generate an activation signal for switching on the power management module; wherein the trigger is configured to generate the activation signal upon detecting at least a threshold level of harvestable power, and thereby switch on the power management module; and wherein the trigger is configured not to generate the activation signal upon detecting less than the threshold level of harvestable power, and thereby switch off the power management module.

Accordingly, it is possible to operate the power management module (PMM) only when a sufficient level of harvestable power (i.e. at least the threshold level) is available, and to keep the PMM off when the level of harvestable power is too low (i.e. below the threshold level). This in turn reduces the power consumption of the PMM.

According to certain embodiments, the input is configured to receive an electrical input from an RF antenna, representative of a level of harvestable power from an RF source. However, in alternative embodiments, the electrical input may be produced by an alternative receiver of harvestable energy, such as a solar cell.

Preferably the trigger comprises a non-inverting Schmitt trigger. Such a non-inverting Schmitt trigger may comprise a nanopower comparator. However, in alternative embodiments, other trigger arrangements may be employed.

According to a second aspect of the invention there is provided a power management module for an energy-harvesting device, further comprising, or coupled to, detector circuitry according to the first aspect of the invention.

According to a third aspect of the invention there is provided an energy-harvesting device comprising detector circuitry according to the first aspect of the invention, coupled to, or incorporated in, a power management module. The energy-harvesting device may be, for example, a wireless sensor device for use in a wireless sensor network (e.g. the so-called “Internet of Things” or “IoT”). However, the present principles are also applicable to other types of energy-harvesting devices, as those skilled in the art will appreciate.

According to a fourth aspect of the invention there is provided a method of controlling the operation of a power management module of an energy-harvesting device, the method comprising: receiving an electrical input representative of a level of harvestable power; generating an activation signal for switching on the power management module upon detecting at least a threshold level of harvestable power, and thereby switching on the power management module; and not generating the activation signal upon detecting less than the threshold level of harvestable power, and thereby switching off the power management module.

As discussed above, in certain embodiments the electrical input is received from an RF antenna, representative of a level of harvestable power from an RF source. The generating of the activation signal may be performed by a non-inverting Schmitt trigger, which may comprise a nanopower comparator. The energy-harvesting device may be, for example, a wireless sensor device.

Advantageously, the method may further comprise performing maximum power point tracking in a sampling time-window that is synchronized with the presence of input harvestable power.

### BRIEF DESCRIPTION OF THE DRAWINGS

Embodiments of the invention will now be described, by way of example only, and with reference to the drawings in which:

FIG. 1 is a schematic diagram of an energy-harvesting device having a source detector circuit coupled to a power management module (PMM), which in turn is coupled to associated circuitry;

FIG. 2 is an example of an RF source detector circuit; and

FIG. 3 shows the RF source detector circuit of FIG. 2 coupled to exemplary PMM circuitry (an equivalent model for PMM circuitry is shown).

In the figures, like elements are indicated by like reference numerals throughout.

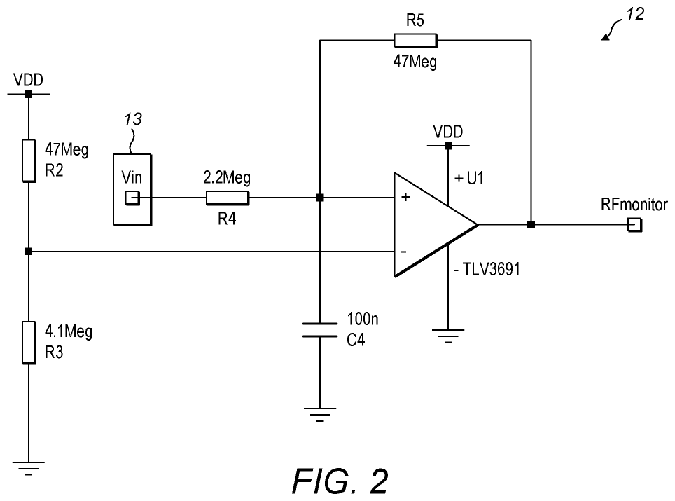

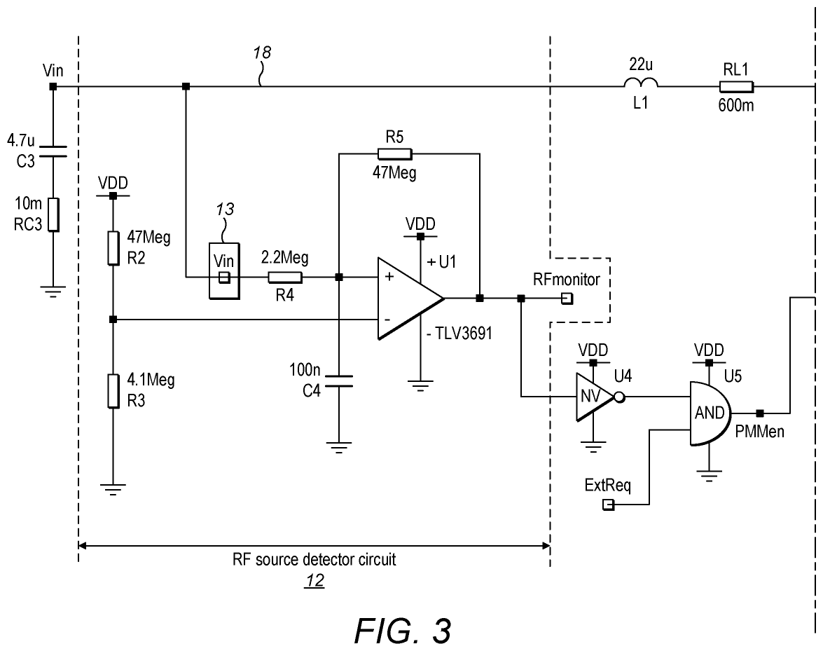

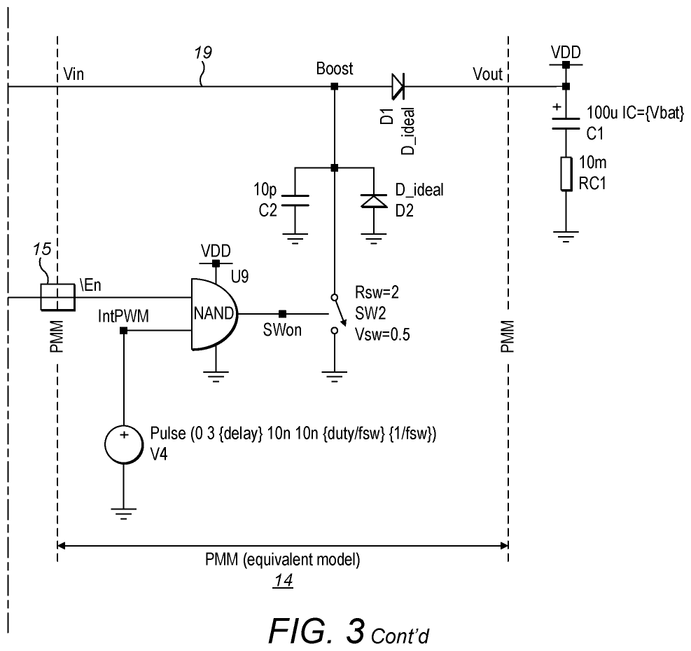

It is to be emphasised that the component values and component reference codes provided in FIGS. 2 and 3 are merely by way of example. As those skilled in the art will appreciate, other component values, and components having alternative reference codes, may be used instead.

### DETAILED DESCRIPTION OF PREFERRED EMBODIMENTS

The present embodiments represent the best ways known to the Applicant of putting the invention into practice. However, they are not the only ways in which this can be achieved.

### Overview

The present work provides detector circuitry for use with a power management module (PMM) within a wireless energy-harvesting device. The detector circuitry is configured to switch on the PMM only when a sufficient level of harvestable power (i.e. at least a threshold level) is available from the harvesting source, at an input to the detector circuitry. The detector circuitry is also configured to keep the PMM off when the level of harvestable power from the source, at the input to the detector circuitry, is too low (i.e. below the threshold level). Thus, this avoids PMM power consumption due to continuous source monitoring and associated processing activities (e.g. Maximum Power Point Tracking (MPPT) action and internal logic consumption).

For energy harvesters that present fast power oscillation in the time domain (as for example RF sources), embodiments of the present invention improve the MPPT too. As the PMM is activated by the source detector circuitry only when there is sufficient available power at the input to the detector circuitry, the sampling time-window of the MPPT (which happens immediately at the start-up of the PMM) is synchronized with the presence of the input power. In this way the proper open circuit voltage of the source is sampled and the input voltage can be adjusted exactly at the Maximum Power Point (MPP) by the PMM.

The present work is applicable to a range of energy-harvesting techniques. Presently-preferred embodiments will be described in relation to the harvesting of energy from an RF source (e.g. a broadcast transmitter or a wireless telecommunications transmitter). However, it will be appreciated that alternative embodiments may be produced in which energy is harvested from other sources (e.g. from sunlight, via a solar cell). In such cases a PMM can still be employed, under the control of detector circuitry in accordance with the present work, with the detector circuitry being responsive to the level of harvestable power received.

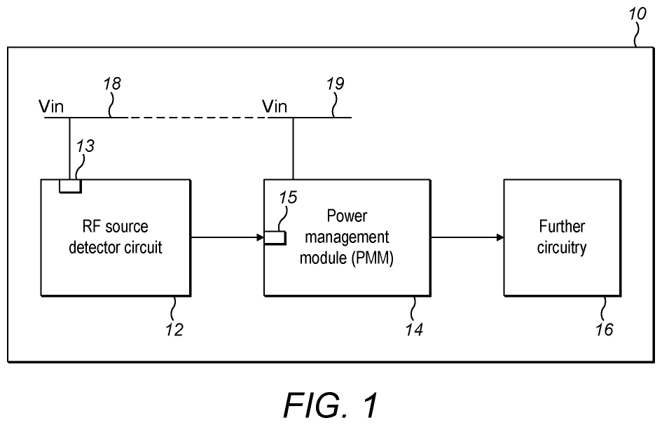

Thus, FIG. 1 illustrates a wireless energy-harvesting device 10 having an RF detector circuit 12 coupled to a PMM 14. The PMM 14 is operably configured to deliver harvested electrical power to further circuitry 16 and/or to an on-board storage element such as a battery or capacitor (not illustrated), to charge it.

The RF detector circuit 12 includes an input 13 coupled to a trigger. The input 13 receives an electrical input from line 18, which is coupled to an RF antenna of the wireless device. The trigger is operable to generate an activation signal upon detecting a sufficient level of harvestable power (i.e. at least a threshold level) via the input 13. The activation signal is sent via suitable interface circuitry to an enabler input 15 of the PMM 14, to switch the PMM 14 on. When switched on, the PMM 14 is then able to harvest electrical power from line 19, which is also coupled to the RF antenna of the wireless device. The PMM 14 can then deliver the harvested power to the further circuitry 16 and/or on-board storage element as noted above.

In a presently-preferred embodiment the wireless energy-harvesting device 10 is a wireless sensor for use in a wireless sensor network (e.g. the so-called “Internet of Things” or “IoT”). Thus, the further circuitry 16 may include sensing means (e.g. for sensing temperature, pressure, or some other parameter(s)), data storage means, data processing means, and a transmitter for sending the sensed data elsewhere within the wireless sensor network.

The trigger does not generate an activation signal upon detecting an insufficient level of harvestable power (i.e. less than the threshold level) via the input 13—in which case the PPM 14 is kept off.

### Source Detector Circuit

FIG. 2 is an example of an RF source detector circuit 12 in more detail. The RF source detector circuit 12 of FIG. 2 is implemented as a voltage detector configured as a non-inverting Schmitt trigger. The principles of Schmitt triggers will be familiar to those skilled in the art of analogue electronics.

The RF source detector circuit 12 of FIG. 2 is configured as a non-inverting Schmitt trigger in order to:
achieve proper start and stop thresholds;
minimize the power consumption—high resistor values and an ultra-low power integrated circuit may be used; this topology allows the circuit to work without an external voltage reference, which significantly affects the power budget;
avoid interferences in the matching between rectifier and PMM; and
avoid unintended modification of the system status, e.g. the PMM switching on in the event of too short a power peak.

In the circuit of FIG. 2, the following components are used to form the non-inverting Schmitt trigger:
U1: nanopower comparator (in this example, Texas Instruments' TLV3691)
R2, R3, R4, R5: resistors (example resistance values are given in Ω)
C4: capacitor (an example capacitance value is given in nF)

In alternative embodiments, different implementations could be used for the source detector circuit 12, including a current detector. However, we have found that a non-inverting Schmitt trigger works very well. Other circuits we tested gave less good current consumption while also affecting the matching between the rectifier and the PMM.

### Connection of the Source Detector Circuit to the PMM

The RF source detector circuit 12 is connected via appropriate interface circuitry to an enabler input 15 (e.g. an enable pin) of the PMM 14, in order to manage the status of the PMM (on: power conversion; off: completely off).

To illustrate this, by way of example, the overall electrical scheme shown in FIG. 3 shows the RF source detector circuit 12 coupled to an equivalent model of a PMM 14.

### Experimental Demonstration and Results

In Table 1 below are indicated the output power (Pₒᵤₜ) and output current (Iₒᵤₜ) of an experimental system at different levels of RF input power (Pᵢₙ). V_{batt} denotes the voltage of the battery (which was used as the power storage element in these tests; another type of storage element, such as a capacitor, may be used instead). In detail, a positive power/current means that the system is a load for the battery; vice versa, negative power/current means that the system is able to recharge the battery. The two scenarios reported in the table are “PMM only” (i.e. a standard state-of-the-art arrangement, without an RF detector circuit) and “RF detector+PMM” (i.e. an arrangement including an RF detector circuit, in accordance with an embodiment of the present invention).

Considering the output power of the PMM, it is possible to notice that the system is activated only when there is enough power at the source to achieve the recharging condition (the current is negative, so it is flowing in the battery). On the other hand, it is important to notice that the power consumption of the system is lower in all the other cases.

TABLE 1
Power consumptions

| | | PMM only | | | RF detector + PMM | | | |
|---|---|---|---|---|---|---|---|---|
| V_{batt} | RF Pᵢₙ | Pₒᵤₜ | Iₒᵤₜ | Status | Pₒᵤₜ | Iₒᵤₜ | Status | |
| [V] | [dBm] | [μW] | [nA] | [1] | [μW] | [nA] | [2] | Notes |
| 3.7 | −40 | 2.564 | 693 | Sleep | 0.673 | 182 | Off | No power |
| | | | | | | | | from source |
| | −15.8 | 1.210 | 327 | Active | 0.596 | 161 | Off | Low power |
| | −12.9 | −1.240 | −335 | Active | −0.459 | −124 | Active | Activation |
| | | | | | | | | threshold |
| | −8.2 | −13.194 | −3566 | Active | −12.391 | −3349 | Active | High power |
| | −20 | 2.449 | 662 | Sleep | 0.574 | 155 | Off | Deactivation |
| | | | | | | | | threshold |

Key:
Status [1]: “Active” = boost on; “Sleep” = PMM sleep
Status [2]: “Active” = boost on; “Off” = no detection

In these measurements no load was applied to the PMM (the worst case for comparison). The present embodiments also avoid any further power consumption from the load (even if forced in deep sleep mode) by switching off completely its power supply.

In order to demonstrate the impact of an embodiment of the present invention in a real IoT application, a power budget of the two scenarios was calculated. For both scenarios was considered:
a lithium battery of 150 mA/3.7V
a typical IoT load with microcontroller start-up plus a BLE (Bluetooth Low Energy) data transmission

In the first scenario (the standard state-of-the-art arrangement, with the PMM only, without an RF detector circuit) the power consumptions and the battery life time expected are set out in Table 2 below:

TABLE 2
Battery life with standard arrangement (no RF detector circuit)
PMM only

| | | Active | Active | | Battery |
|---|---|---|---|---|---|
| V_{batt} | PMM | load | time | Activations | Life |
| [V] | [μA] | [μA] | [ms] | per day | [days] |
| 3.7 | 0.800 | 11700 | 1.6 | 10 | 427 |

In the second scenario, in which an embodiment of the invention is implemented, the power consumptions and the expected battery life are set out in Table 3 below:

TABLE 3
Battery life with PMM and RF detector circuit
RF detector + PMM

| | RF | Active | Active | | Battery |
|---|---|---|---|---|---|
| V_{batt} | detector + | load | time | Activations | Life |
| [V] | PMM [μA] | [μA] | [ms] | per day | [days] |
| 3.7 | 0.300 | 11700 | 1.6 | 10 | 1110 |

Thus, it can be seen that, through implementing an embodiment of the present invention, a significantly longer battery life can be achieved for the IoT device.

The current consumption of a standard state-of-the-art PMM arrangement is around 700 nA, whereas the current consumption of an embodiment of the present invention (including an RF detector circuit) is around 200 nA (both measured with no input power available). Thus, the present embodiment allows a reduction of 70% of the harvester power consumption during the standby condition (with no input power available).

### POSSIBLE MODIFICATIONS AND ALTERNATIVE EMBODIMENTS

Detailed embodiments have been described above, together with some possible modifications and alternatives. As those skilled in the art will appreciate, a number of additional modifications and alternatives can be made to the above embodiments whilst still benefiting from the inventions embodied therein.

For example, in the above embodiments, the detector circuitry is configured to receive an electrical input from an RF antenna, representative of a level of harvestable power from an RF source. However, in alternative embodiments, the electrical input may be produced by an alternative receiver of harvestable energy, such as a solar cell. In such a case, the detector circuitry can cause the PMM to operate only when a sufficient (threshold) level of light for energy-harvesting purposes is received by the solar cell.

In the above embodiments the trigger comprises a non-inverting Schmitt trigger. However, in alternative embodiments, other trigger implementations may be used, such as a current detector.

In the above embodiments the energy-harvesting device in which the detector circuitry is employed (in conjunction with a PMM) is a wireless sensor device for use in a wireless sensor network. However, other types of energy-harvesting devices may be produced which employ the present detector circuitry principles, together with a PMM.

Although, in the above embodiments, the detector circuitry is shown as separate from (but coupled to) the PMM, in other embodiments the detector circuitry may be incorporated in the PMM.

1. Detector circuitry for controlling the operation of a power management module of an energy-harvesting device, the detector circuitry comprising:
an input for receiving an electrical input representative of a level of harvestable power; and
a trigger coupled to the input and operable to generate an activation signal for switching on the power management module;
wherein the trigger is configured to generate the activation signal upon detecting at least a threshold level of harvestable power, and thereby switch on the power management module; and
wherein the trigger is configured not to generate the activation signal upon detecting less than the threshold level of harvestable power, and thereby switch off the power management module.

2. Detector circuitry according to claim 1, wherein the input is configured to receive an electrical input from an RF antenna, representative of a level of harvestable power from an RF source.

3. Detector circuitry according to claim 1, wherein the trigger comprises a non-inverting Schmitt trigger.

4. Detector circuitry according to claim 3, wherein the non-inverting Schmitt trigger comprises a nanopower comparator.

5. A power management module for an energy-harvesting device, further comprising, or coupled to, detector circuitry for controlling the operation of the power management module, the detector circuitry comprising:
an input for receiving an electrical input representative of a level of harvestable power; and
a trigger coupled to the input and operable to generate an activation signal for switching on the power management module;
wherein the trigger is configured to generate the activation signal upon detecting at least a threshold level of harvestable power, and thereby switch on the power management module; and
wherein the trigger is configured not to generate the activation signal upon detecting less than the threshold level of harvestable power, and thereby switch off the power management module.

6. The power management module according to claim 5, configured to perform maximum power point tracking in a sampling time-window that is synchronized with the presence of input harvestable power.

7. The power management module according to claim 5, being part of an energy harvesting device.

8. The power management module according to claim 7, wherein the energy harvesting device is a wireless sensor device.

9. (canceled)

10. A method of controlling the operation of a power management module of an energy-harvesting device, the method comprising:
receiving an electrical input representative of a level of harvestable power;
generating an activation signal for switching on the power management module upon detecting at least a threshold level of harvestable power, and thereby switching on the power management module; and
not generating the activation signal upon detecting less than the threshold level of harvestable power, and thereby switching off the power management module.

11. The method according to claim 10, wherein the electrical input is received from an RF antenna, representative of a level of harvestable power from an RF source.

12. The method according to claim 10, wherein the generating of the activation signal is performed by a non-inverting Schmitt trigger.

13. The method according to claim 12, wherein the non-inverting Schmitt trigger comprises a nanopower comparator.

14. The method according to claim 10, wherein the energy-harvesting device is a wireless sensor device.

15. The method according to claim 10, further comprising performing maximum power point tracking in a sampling time-window that is synchronized with the presence of input harvestable power.

16. The power management module according to claim 5, wherein the input of the detector circuitry is configured to receive an electrical input from an RF antenna, representative of a level of harvestable power from an RF source.

17. The power management module according to claim 5, wherein the trigger comprises a non-inverting Schmitt trigger.

18. The power management module according to claim 17, wherein the non-inverting Schmitt trigger comprises a nanopower comparator.

19. The power management module according to claim 16, being part of an energy harvesting device.

20. The power management module according to claim 17, being part of an energy harvesting device.

21. The power management module according to claim 6, being part of an energy harvesting device.
